(19) United States
(12) Patent Application Publication
(10) Pub. No.: US 2008/0195686 A1
(43) Pub. Date: Aug. 14, 2008

(54) Information Data Distribution System, Distribution Method, and Information Data Storage Terminal

(75) Inventors: Masayoshi Son, Tokyo (JP); Taizo Son, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SOFTBANK BB CORP., Tokyo (JP)

(21) Appl. No.: 11/577,636

(22) PCT Filed: Oct. 20, 2005
(86) PCT No.: PCT/JP05/19337

§ 371 Date: Jan. 11, 2008

(30) Foreign Application Priority Data
Oct. 21, 2004 (JP) 2004-307462

(51) Int. Cl. G06F 15/16

(52) U.S. Cl. 709/201

(57) ABSTRACT

Information data accumulated in a content database 9 arranged on the Internet 7 is acquired in a relay device 6. A music file 3 is outputted from a street loudspeaker 5 connected to the relay device 6. Simultaneously with or prior to the output processing via the street loudspeaker 5 by a radio LAN base 4 connected to the relay device 6, the music file 3 is distributed by radio communication. In a user terminal 2 used by a user, one information data received from the distribution device is temporarily stored in a cache memory 25. According to a user operation, the music file 3 accumulated in the cache memory 25 is written into a memory 24. Thus, by push-type distribution, it is possible to enhance the user willingness to buy and distribute a content without missing the chance to sell the content.

### TECHNICAL FIELD

The present invention relates to a system and method for distributing information data including a sound, a picture, a character string or the like through a communication network which is constructed by connecting communication lines with each other, and an information data storage terminal.

### BACKGROUND ART

In recent years, there are available services for selling information data (content data) including audio data such as music, video data such as movies, text data such as novels and the like through digital broadcasting and communication networks such as the Internet.

Patent Document 1 discloses an example of the technique for distributing such information data. The technique disclosed in this Patent Document 1 relates to a system which is provided for utilizing digital content by a content utilization device and provided with a distribution center for distributing content and the like, a content utilization device for utilizing content, and a network for connecting them. The distribution center is provided with a charge server for performing charging, a license management server for managing and granting the right (license) to use content, a distribution server for distributing content and so forth.

Then, in the case of the technique which is disclosed in this Patent Document 1, the licenses of content owned by each user or each content utilization device are managed by the license management server, and delivered to the content utilization device through the network on the basis of content selection operation by the user. Alternatively, in the case of the push-type information distribution service such as digital broadcasting, temporarily invalidated licenses are distributed together with content, and the charging process is performed at the content utilization device in order to validate the licenses and makes it possible to use the content.

Thereafter, the content for which license has been given is provided, for example, by streaming distribution or downloading in the case of the Internet distribution or by transmitting stream-type content in the case of digital broadcasting.
Patent Document 1: Japanese Patent Published Application No. 2004-145867

### SUMMARY OF THE INVENTION

However, in the case of the technique disclosed in Patent Document 1 as described above where the downloading process through a network or the like process is performed to distribute content on the basis of user's operation of selecting content, there is a problem in that it is possible to sell only the content which the user wants to buy.

Taking into consideration the above circumstances, it is an object of the present invention to provide an information distribution system, a distribution method and an information data storage terminal in which it is possible to enhance the user willingness to buy by the push-type information distribution and distribute content without missing the chance to sell the content.

In order to accomplish the object as described above, according to the present invention includes the steps of, when information data including a sound, a picture, a character string or the like is distributed through a communication network which is constructed by connecting communication lines with each other, acquiring the information data, which is accumulated in an information data accumulation device located on the communication network, by a relay device through the communication network; outputting the information data in the form of a sound or an image from an output terminal connected to the relay device, and distributing the information data through wireless communication by a distribution device connected to the relay device simultaneously with the output process of the output terminal or in advance of the output process; and temporarily accumulating the information data which is received from the distribution device in a cache memory, and saving (hereinafter referred to as “real saving”) in a storing device the information data which is accumulated in the cache memory in response to user operation.

In accordance with the present invention as described above, it is possible to have the user view and listen to the information data, which is accumulated in the information data accumulation device, by the use of the output terminal, and thereby it is possible to enhance the user willingness to buy. Then, information data is distributed simultaneously with or in advance of the output processing through this output terminal in order to temporarily accumulate the information data in the cache memory of the user terminal in advance, and thereby when the user wants to purchase and performs purchase operation, the information data can be really saved in the storing device from the cache memory without delay. As a result, it is possible to make the time when the user is encouraged to buy and the time when the information data is acquired approximately coincide with each other, and thereby not to miss the chance of selling information data.

In accordance with the above invention, it is preferred that a management device is located on the communication network to store, in association with each other, user information for identifying the user and a title saving right issued as a right to view and listen to the information data which is purchased by the user, that the user terminal transmits a purchase request to the management device when performing the real saving, and the management device determines, in accordance with the purchase request, whether or not there is a title saving right corresponding to the request, and permits the user terminal to perform the real saving under the condition that the tide saving right exists, but if the title saving right does not exist, the information data accumulated in the cache memory is discarded.

In this case, a title saving right can be acquired by a user as a right to view and listen to information data and saved in the management device on the communication network, and thereby it is possible to perform the charging process and so forth while reducing the communication load and communication time.

In accordance with the above invention, it is preferred to provide the functionality of, when deleting the information data which is really saved in the storing device, leaving only license information which identifies the title saving right of the information data, and the information data accumulation device delivers, in response to a delivery request providing the license information, the information data corresponding to the request without confirming the title saving right by the management device.

In this case, even if the information data which is really saved is deleted, the license information is left in the user terminal so that download can be performed again without confirming whether or not there is a title saving right. In addition, since the playback process is performed in association with the redelivery request providing the license information thereof, the user can perform the playback operation without awareness of whether or not the information data exists in the user terminal.

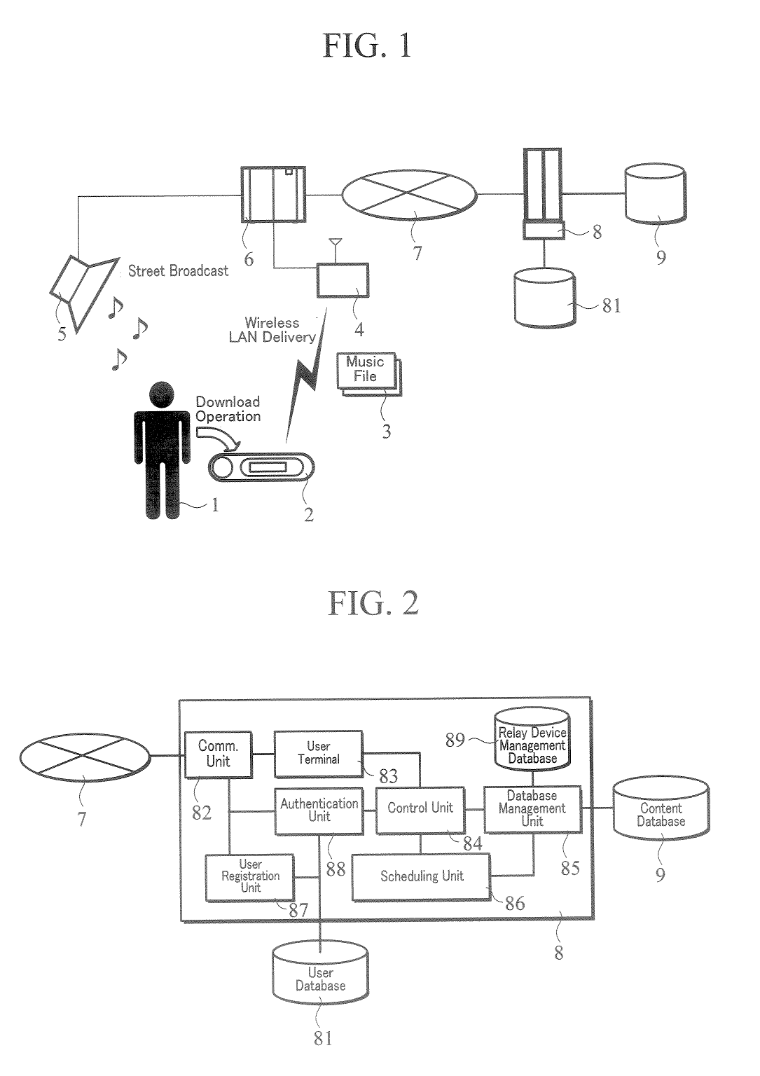

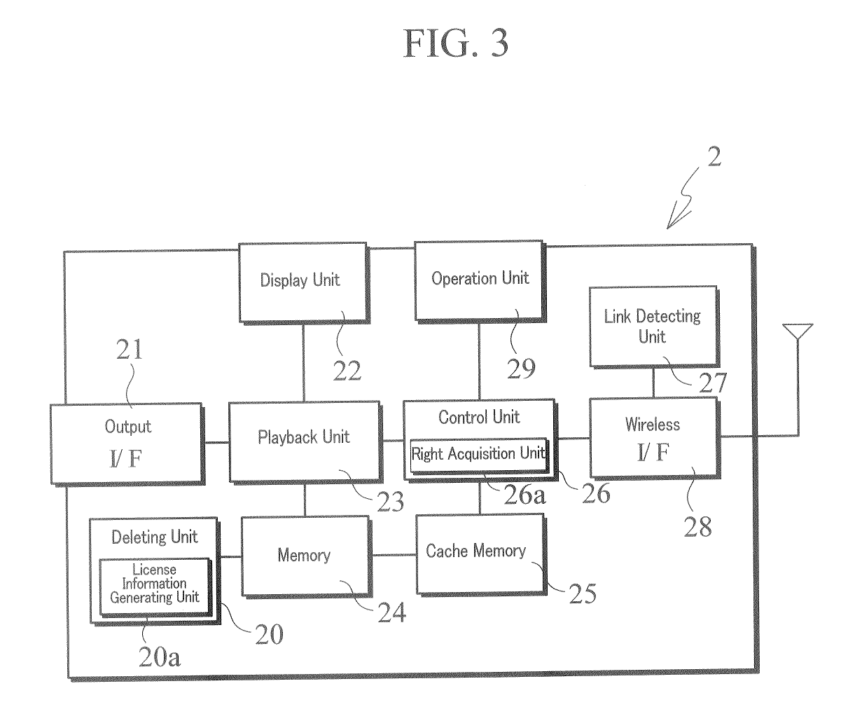

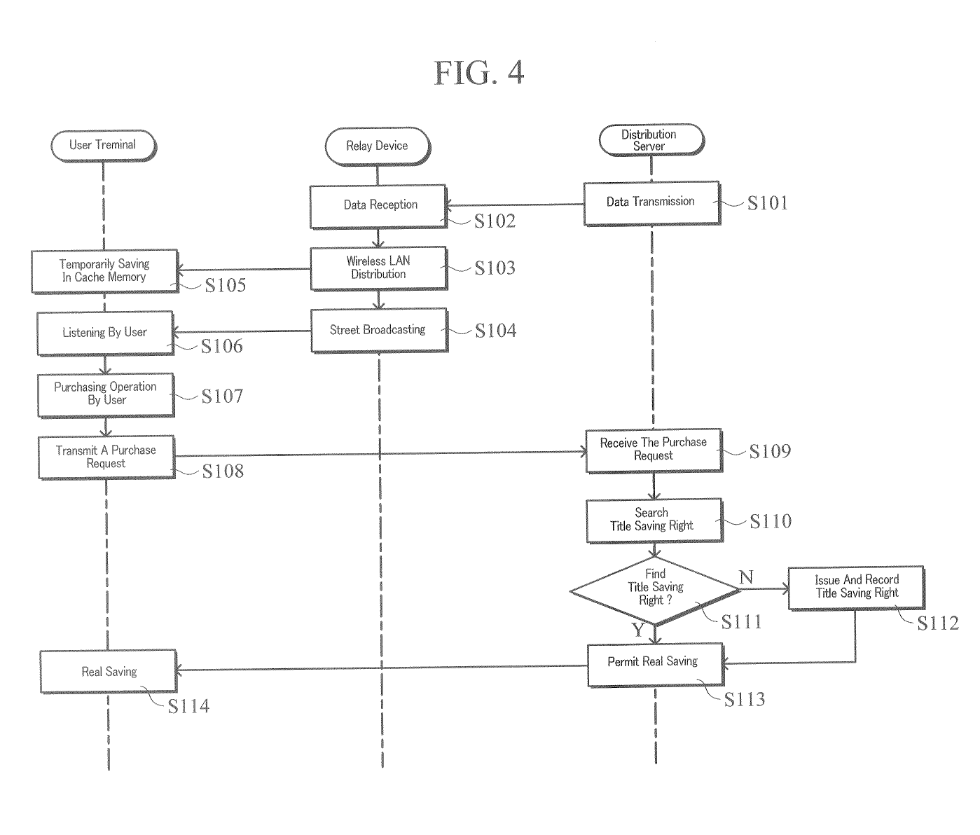

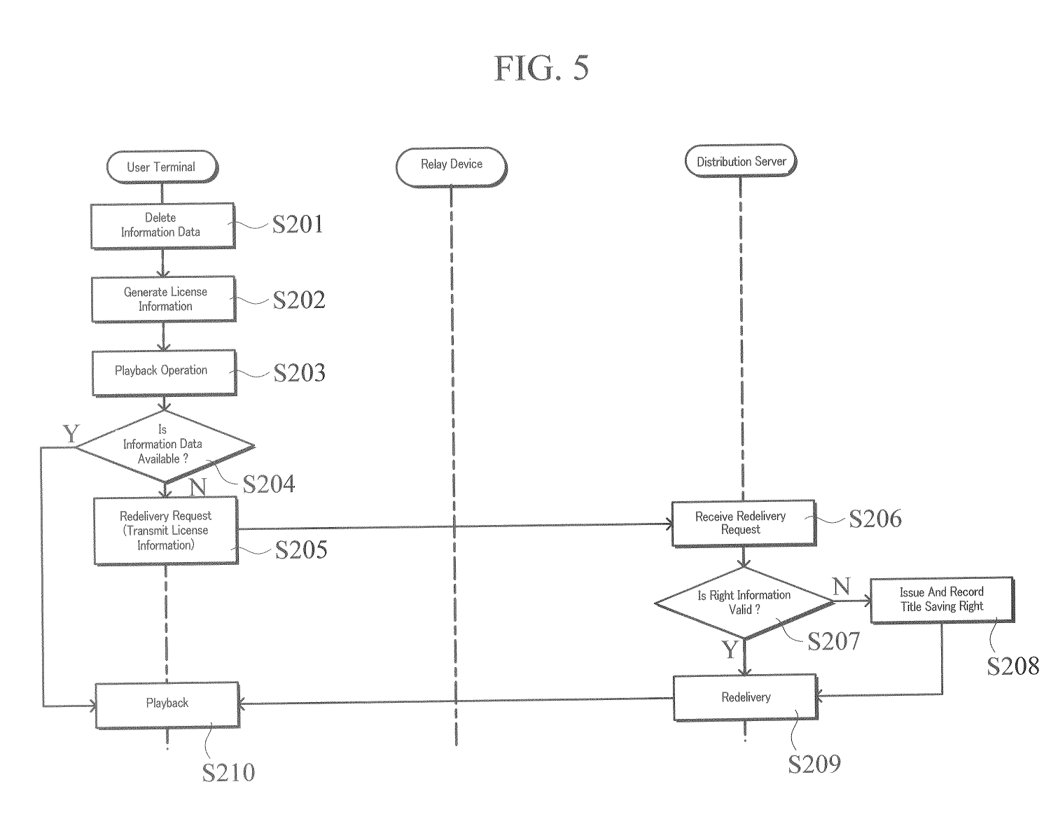

### BRIEF DESCRIPTION OF THE DRAWINGS

[FIG. 1] An explanatory view for schematically showing the configuration of the information distribution system in accordance with an embodiment.

[FIG. 2] A block diagram for showing the internal structure of the distribution server in accordance with the embodiment.

[FIG. 3] A block diagram for showing the internal structure of the user terminal in accordance with the embodiment.

[FIG. 4] A sequence diagram showing the operation of the distribution system according to the present invention when distribution is performed.

[FIG. 5] A sequence diagram showing the operation of the distribution system according to the present invention when redelivery is performed.

### BEST MODE FOR CARRYING OUT THE INVENTION

(Configuration of the System)

An embodiment of the present invention will be explained with reference to the accompanying drawings. FIG. 1 is a view for schematically showing the configuration of the information distribution system in accordance with the present embodiment.

As shown in the same figure, the information distribution system is a system for distributing music files 3 through the Internet 7, and provided with a distribution server 8 and a content database 9 which are located on the Internet 7, a relay device 6 for acquiring the music files 3 from the content database 9, a street loudspeaker 5 and a wireless LAN base station 4 which are connected to the relay device 6, and a user terminal 2 which is used by a user 1.

The Internet 7 is a distributed communication network (IP network) which is constructed by connecting a variety of communication lines (a telephone line, an ISDN line, a public network such as an ADSL line, a dedicated communication line, and a radio communication network) to each other by the use of the communication protocol TCP/IP. This communication network may be a LAN such as an intranet (a network within a company), home networking and the like based on 10BASE-T, 100BASE-TX or the like.

The relay device 6 is provided with a communication interface such as a modem and/or a terminal adapter for connecting with the Internet 7 and a storage device such as a hard disk or a memory, serves as a device for downloading and accumulating the information data from the content database 9 in accordance with the instruction from the distribution server 8, and can be implemented for example as a set-top box. In addition, this relay device 6 transmits the information data accumulated in itself to the street loudspeaker 5 and the wireless LAN base station 4 in accordance with the instruction from the distribution server 8 in order to perform street broadcasting and wireless LAN distribution.

The street loudspeaker 5 is an output device for broadcasting, as sounds, the audio data (the music files 3 in FIG. 1) contained in the information data, which is output from the relay device 6, under the control of the relay device 6. When the information data is an MPEG (Moving Picture Experts Group) file and the like containing sounds and pictures, the audio data contained therein is output as sounds. Incidentally, while the output device for outputting the information data is a street loudspeaker only capable of outputting sounds in the case of the present embodiment, it can be replaced by a display capable of displaying images, an electronic bulletin board capable of displaying text strings and so forth, or a combination thereof.

The wireless LAN base station 4 is a base station of LAN (Local Area Network) for transmitting and receiving information data through radio communication, and serves as an access point for transmitting and receiving data with a plurality of user terminals in conformity with a wireless LAN standard such as IEEE802.11b. Also, a common ESSID (Extended Service Set Identifier) is assigned to the wireless LAN base station 4 and the respective user terminals so that the user terminals located within the communication area of the base station are detected to automatically set links and form a hot spot of the wireless LAN. Incidentally, while a wireless LAN is used as a wireless communication system in the case of the present embodiment, Bluetooth or the like can be used for the same purpose.

(Configuration of Distribution Server)

The distribution server 8 is implemented as a server computer or software capable of transmitting, in a document system of the WWW (World Wide Web) or the like, information data such as HTML (HyperText Markup Language) files, image files, music files and the like, and serves to accumulate information such as HTML files or image files and distribute the information data through the Internet 7 in response to a request from a Web browser or any other client software. Incidentally, while the music files 3 such as MP3 (Mpeg Audio Layer-3) or WMA (Windows Media Audio; Registered Trademark) files are distributed as information data in the case of the present embodiment, other content files, for example, motion picture files such as MPEG files and text files can be also treated.

The content database 9 is implemented in or externally connected to the distribution server 8, and serves as an information data accumulating device which can be accessed by the distribution server 8 through the Internet 7 and implemented with a hard disk of a large capacity and the like. The information accumulated in this content database 9 includes, besides the information data itself, index data for associating the data IDs of the respective information data items with the types of the information data (music, voice, images, character strings and the like), the file formats and the attribute information (genres or ages) of the information data.

Then, this content database 9 performs reading and writing the information data under the control of the distribution server 8. The control of this distribution server 8 is performed, for example, by accessing an information data item with reference to the identifier (an address or file name stored in the database) for identifying the information data item or accessing the information data item with reference to the type, file format, attribute of the information data or other information of the index data.

More specifically speaking, as shown in FIG. 2, the distribution server 8 is provided with a database management unit 85 for managing data input to or output from databases such as the content database 9 and a relay device management database 89. The relay device management database 89 is a database in which the device IDs of the relay devices located in the respective areas are registered in association with the installation sites (names of places and the like), the attributes of the installation sites (station yards, department stores, streets and the like), the attributes of the installation areas (metropolitan area, local area, commercial area, recreation area and the like) and the like.

Also, the distribution server 8 is provided with a scheduling unit 86 for performing scheduling in order to control the distribution of information data to the relay device located in each area. This scheduling unit 86 sets schedules as to what time slot, what information data and to which relay device, the distribution is to be performed in accordance with the information accumulated in the content database 9 and the relay device management database 89, and accumulates the schedule information. A control unit 84 controls the database management unit 85 in accordance with this schedule information, reads predetermined information data, and distributes the information data to the respective relay devices through the information distributing unit 83 and the communication unit 82.

The communication unit 82 is a communication device for transmitting and receiving various data through the Internet 7 by transmitting and receiving packet data. In addition, the information distributing unit 83 is a module for packetizing information data and decoding the information data from packet data.

Furthermore, the distribution server 8 is provided with an authentication unit 88 for determining permission for writing information data and a user registration unit 87 for accepting user registration to receive the service from the present system.

The authentication unit 88 is a computer or software capable of verifying the authority of the accessing user, and serves as a module for acquiring the combination of a user name and a password through the Internet 7 and searching the user database 81 in order to confirm whether or not the accessing user is authorized, whether or not the accessing person is identified as the user and so forth.

In addition to this, the authentication unit 88 has the functionality of accepting a purchase request from the user terminal 2, confirming whether or not the user making the purchase request possesses a title saving right, and permitting the user to really save the data in a memory 24 from a cache memory 25 only when the user possesses the title saving right.

More specifically speaking, the user database 81 stores, as user information, user IDs for identifying the respective users and the purchase history of the information data of the respective users in association with each other, and the user information contains the list of the title saving rights possessed by the respective users.

This title saving right is the right of viewing and listening to information data and serves as information for managing the respective information data in order that it is not needed to perform again the purchase operation (charging process) with respect to the information data that has been already purchased. Once this title saving right is acquired, even if download is requested again from a user terminal which is different from the user terminal used for performing the purchase operation, it is permitted to really save the information data without requiring the purchase operation again. On the other hand, when the user does not possess the title saving right, the title saving right is issued and registered in the user database 81.

Meanwhile, it is possible to perform the charging process of the information data purchased by the user on the basis of this title saving right. Also, it is possible to provide an expiration date for a title saving right and automatically delete the expired title saving right from the user database 81.

In addition to this, when receiving a delivery request containing license information (the license ID identifying the title saving right of the information data which is information data already purchased and deleted from the user terminal 2) from the user terminal 2, the authentication unit 88 is provided with the functionality of delivering the information data relating to the delivery request from the information distributing unit 83 without confirming whether or not there is a title saving right. Incidentally, in the case where an expiration date is designated in regard to a title saving right, it is possible to determine whether or not to redeliver by searching the user database 81 on the basis of the license ID.

Furthermore, the authentication unit 88 according to the present embodiment acquires, together with the license ID, the terminal ID of the user terminal which generates the license ID (i. e., the user terminal which performs the deletion of the information data already purchased) and the terminal ID of the user terminal which is requesting redelivery, and determines whether or not the user terminal which performs the deletion is the same as the user terminal which is requesting redelivery, and performs redelivery only when they are the same terminal.

The distribution server 8 is provided with a user registration unit 87 which serves to register a user who wishes to receive the service of the present system. When this user registration is performed, it is required to register the information about the way of payment such as card information besides the personal information of the user in order to dispense with repeatedly inputting the way of payment each time the user performs really saving data.

(Configuration of User Terminal)

The user terminal 2 is a terminal device provided with the functionality of performing wireless communication with the radio LAN base 4, the functionality of accumulating the information data which is downloaded, and the functionality of playing back the information data which is accumulated, and can be implemented with a mobile terminal device such as a mobile computer or PDA (Personal Digital Assistance) capable of running a purpose-built application, a silicon player which is provided with the above functionality, and the like device.

Specifically, as shown in FIG. 3, the user terminal 2 according to the present embodiment is provided with a wireless interface 28 and a link detecting unit 27 for implementing wireless communication ability. The wireless interface 28 is a transmitter receiver device for wireless LAN connection in compliance with IEEE802.11b, and given an ESSID which is common with the radio LAN base 4. Meanwhile, in the case of the mobile computer or PDA, this wireless interface can be implemented with a wireless LAN adaptor or the like. In addition, the link detecting unit 27 monitors wireless signals, detects the ESSID for identifying the radio LAN base 4, and notifies a control unit 26 of this detection result to establish a link with the radio LAN base 4 for transmitting and receiving data.

The control unit 26 is an arithmetic processing unit such as a CPU for controlling the respective functions of the user terminal 2, and serves to transmit a terminal ID stored in the memory 24 or the like for identifying itself and a password (which is input through user operation if necessary) to one radio LAN base 4 in order to sec up the link with the radio LAN base 4. Also, the control unit 26 is connected to an operation unit 29 such as buttons, a touch panel, a jog dial and the like, and provided with the functionality of accepting an operation signal through user operation.

In addition to this, the user terminal 2 is provided with the cache memory 25 and the memory 24 in order to provide the functionality of accumulating information data. The cache memory 25 is for example a volatile memory device and serves to temporarily save the information data which is downloaded. In addition, the memory 24 is a storage device in which is written and stored (really saved) the information data which is purchased by the user and for which a title saving right is acquired, and can be implemented with a non-volatile memory, a hard disk or the like. Meanwhile, this memory 24 may be fixedly installed within the user terminal 2, may be a detachable device such as a memory card, or may be a storage device which is connected through a USB cable or the like.

The memory 24 is provided with a deleting unit 20 for deleting data from the memory 24. The deleting unit 20 is a module for automatically deleting data in response to user operation or when there is left only a limited available memory space. This deleting unit 20 performs automatic data deletion in accordance with the order of priority and deletion conditions, for example, from such data as less frequently played back or such data as stored for a long period (or short period), or in accordance with the data type. This order of priority and deletion conditions can be arbitrarily determined on the user side or the service provider side.

In addition, the deleting unit 20 is provided with the functionality of generating, with respect to the information data which is deleted, license information (license ID) about the title saving right of the information data, and accumulating the license information in the memory 24 as a title list.

Furthermore, the user terminal 2 is provided with a playback unit 23, a display area 22 and an output interface 21 for implementing the functionality of playing back the information data which is accumulated. The playback unit 23 is a module provided with a decoder for restoring compressed data and decoding encrypted data, and an encoder for converting the data format in conformity with the output interface 21. This playback unit 23 is capable of outputting sounds through a built-in speaker, an earphone connected to the output interface 21 or the like, and outputting pictures and character strings through the display area 22, a display connected to the output interface 21 or the like.

In addition to this, the playback unit 23 is provided with the functionality of transmitting the license information generated by a license information generating unit 20a to the distribution server 8 when user operation is performed to play back the information data which is deleted, and requesting redelivery of the information data corresponding to the user operation.

The above control unit 26 is provided with a right acquisition unit 26a which, when really saving data, transmits a purchase request to the distribution server 8, queries the distribution server 8 as to whether or not there is a title saving right with respect to the information data to be really saved, and really saves the information data only when the distribution server 8 permits the real saving, otherwise deletes the information data from the cache memory 25.

(Distribution Method)

The distribution method according to the present invention can be performed by running the information distribution system having the structure as described above. FIG. 4 is a sequence diagram showing the operation of the distribution method according to the present invention.

First, the scheduling unit 86 of the distribution server 8 makes a schedule of distributing information data. Then, the control unit 84 reads the music files 3 from the content database 9 in accordance with this schedule, and transmits them to the relay device 6 in step S101. When receiving the music files in step S102, the relay device 6 performs wireless LAN distribution through the radio LAN base 4 in step S103. In this case, it is assumed that the user terminal 2 of the user 1 is located in the transmission area of the radio LAN base 4. The user terminal 2 temporarily saves the music files 3 distributed through the wireless LAN in the cache memory 25 in step S105.

At the same time as this radio LAN base 4 performs the wireless LAN distribution or after the wireless LAN distribution, the relay device 6 broadcasts the sound of the music file 3 through the street loudspeaker 5 in step S104. It is assumed that this broadcasting is performed within the transmission area of the radio LAN base 4 and that the user 1 listens to the broadcasting, likes this music he listens to and decides to buy this music. The user 1 operates the operation unit 29 for purchasing the music file and really saving it in step S107. In response to this operation, the control unit 26 of the user terminal 2 transmits a purchase request to the distribution server 8 through the wireless interface 28 in step S108.

When receiving this purchase request in step S109, the distribution server 8 performs user authentication by the authentication unit 88. At this time, if the user 1 has not yet performed user registration, the notification that really saving is not permitted is provided to the user terminal 2 without searching for the title saving right in the latter step, and the process of performing user registration through the user registration unit 87 is required if necessary. Incidentally, in this case, it is assumed that the user 1 is a registered user.

After completing the authentication of the user 1 and confirming that the user 1 is a registered user, the authentication unit 88 performs a search of the user database 81 as to whether or not the user 1 possesses the title saving right of the information data corresponding to the purchase request in step S110. If the user does not possess the title saving right (i.e., the “N” branch from step S111), the title saving right is issued and stored in the user database 81 in step S112. In the case of the present embodiment, charging for the purchase of information data is collectively performed at a later date with reference to she user information (name, card information and the like) recorded in the user database 81.

On the other hand, when the title saving right is confirmed in step S111, or when a title saving right is issued in step S112, the permission of real saving is transmitted to the user terminal 2. The user terminal 2 given this permission writes the music file, which is temporarily stored in the cache memory 25, to the memory 24, and the real saving process is finished in step S114. Meanwhile, in the case of the present embodiment, when the real saving process is permitted, the user terminal 2 is notified of the license ID of the title saving right which is issued, and performs the process of real saving the information data in association with the license ID.

Then, as shown in FIG. 5, in response to the user operation or when the balance of the memory 24 decreases, the deleting unit 20 deletes the information data which matches the deleting condition in step S201. When the information data is deleted, the license information generating unit 20a of the deleting unit 20 generates license information (license ID and the like) relating to the title saving right of the information data to be deleted, and saves it in the memory 24 in step S202.

It is assumed that, thereafter, the user performs the playback operation of the information data which is deleted in step S203. The playback unit 23 determines whether or not the information data to be played back exists in the memory 24 in step S204, and if it exists (i.e., the “Y” branch from seep S204), it is played back in step S210. On the other hand, if there is not the information data (i.e., the “N” branch from step S204), the playback unit 23 transmits the redelivery request containing the license information to the distribution server 8 in step S205.

When receiving the redelivery request in step S206, the distribution server 8 determines in step S207 whether or not the license information contained in the redelivery request is valid, and if it is not valid (i.e., the “N” branch from step S207), the distribution server 8 issues a title saving right and records it in the user database 81 in step S208. If the license information is valid (i.e., the “Y” branch from step S207), or after the title saving right is issued, the distribution server 8 performs the redelivery of the information data to the user terminal 2 in steps S209 and S210.

(Actions/Effects)

In accordance with the distribution system and distribution method of the present embodiment, it is possible to have the user 1 view and listen to information data by street broadcasting, through the street loudspeaker 5, the information data which is accumulated in the content database 9, and thereby it is possible to encourage the user 1 to buy. Then, information data is distributed from the radio LAN base 4 simultaneously with or in advance of the output processing through this street loudspeaker 5 in order no temporarily accumulate the information data in the cache memory 25 of the user terminal 2 in advance, and thereby when the user 1 wants to purchase and performs purchase operation, the information data can be really saved in the memory 24 from the cache memory 25 without delay. As a result, it is possible to make the time when the user 1 is encouraged to buy and the time when the information data is acquired approximately coincide with each other, and thereby not to miss the chance of selling information data.

Also, in the case of the present embodiment, a title saving right is issued for a user as a right to view and listen to information data and saved in the distribution server 8 on the Internet 7, and thereby it is possible to reduce troublesome operation by the user and reduce the communication load and communication time. In addition, it is possible to easily perform the process of charging the user with reference to the title saving right.

Furthermore, in the case of the present embodiment, when deleting the information data which is really saved in the memory 24, the license information generating unit 20a leaves only license information which identifies the title saving right of the information data, and thereby even if the information data really saved in the user terminal 2 is deleted it is possible to easily download the information data again without reissuing the title saving right.

Also, in the case of the present embodiment, since the playback process is performed by the playback unit 23 in association with the redelivery request providing the license information thereof, the user 1 can perform the playback operation without awareness of whether or not the information data exists in the user terminal.

### INDUSTRIAL APPLICABILITY

As has been discussed above, in accordance with the present invention, the user is encouraged to buy by outputting sound or image information data through an output terminal, and by temporarily accumulating information data in the cache memory of a user terminal it is possible to make the time when the user is encouraged to buy and the time when the information data is acquired approximately coincide with each other, and thereby provide content without missing the chance of selling information data.

What is claimed is:

1. A distribution system for distributing information data including a sound, a picture, a character string or the like through a communication network which is constructed by connecting communication lines with each other, said system comprising:
an information data accumulation device located on said communication network and operable to accumulate said information data;
a relay device operable to acquire said information data from said information data accumulation device through said communication network;
an output terminal connected to said relay device and operable to output said information data in the form of a sound or an image;
a distribution device connected to said relay device and operable to distribute said information data through wireless communication simultaneously with the output process of said output terminal or in advance of the output process; and
a user terminal provided with the functionality of temporarily accumulating the information data which is received from said distribution device in a cache memory, saving (hereinafter referred to as “real saving”), in a storing device, the information data which is accumulated in the cache memory in response to user operation.

2. The distribution system as claimed in claim 1 further comprising a management device operable to store, in association with each other, user information for identifying said user and a title saving right issued as a right to view and listen to the information data which is purchased by said user, and
wherein said user terminal transmits a purchase request to said management device when performing said real saving, and
wherein said management device determines, in accordance with said purchase request, whether or not there is a title saving right corresponding to said request, and permits said user terminal to perform said real saving under the condition that the title saving right exists, but if the title saving right does not exist, the information data accumulated in said cache memory is discarded.

3. The distribution system as claimed in claim 1 wherein said user terminal is provided with the functionality of leaving only license information which identifies the title saving right of said information data when deleting the information data which is really saved, and
wherein said information data accumulation device delivers, in response to a delivery request providing said license information, the information data corresponding to the request without confirming the title saving right by said management device.

4. A distribution method for distributing information data including a sound, a picture, a character string or the like through a communication network which is constructed by connecting communication lines with each other, said method comprising;
a step (1) of acquiring said information data, which is accumulated in an information data accumulation device located on said communication network, by a relay device through said communication network;
a step (2) of outputting said information data in the form of a sound or an image from an output terminal connected to said relay device, and distributing said information data through wireless communication by a distribution device connected to said relay device simultaneously with the output process of said output terminal or in advance of the output process; and
a step (3) of temporarily accumulating the information data which is received from said distribution device in a cache memory, and really saving in a storing device the information data which is accumulated in the cache memory in response to user operation.

5. The distribution method as claimed in claim 4 wherein there is located on said communication network a management device operable to store, in association with each other, user information for identifying said user and a title saving right issued as a right to view and listen to the information data which is purchased by said user, and wherein
in the step (3):
said user terminal transmits a purchase request to said management device when performing that real saving of the information data in said storing device, and
said management device determines, in accordance with said purchase request, whether or not there is a title saving right corresponding to said request, and permits said user terminal to perform said real saving under the condition that the title saving right exists, but if the title saving right does not exist, the information data accumulated in said cache memory is discarded.

6. The distribution method as claimed in claim 5 wherein said user terminal is provided with the functionality of leaving only license information which identifies the title saving right of said information data when deleting the information data which is really saved, and wherein
in the step (3):
said information data accumulation device delivers, in response to a delivery request providing said license information, the information data corresponding to the request without confirming the title saving right by said management method.

7. An information data storage terminal for receiving information data including a sound, a picture, a character string or the like through a communication network which is constructed by connecting communication lines with each other, said terminal comprising:
a receiving unit operable to receive said information data, which is accumulated in an information data accumulation device located on said communication network, through wireless communication connected to said communication network;
a cache memory operable to temporarily accumulate the information data which is received; and
a storing device operable to really save the information data, which is accumulated in the cache memory, in response to user operation.

8. The information data storage terminal as claimed in claim 7 wherein, when performing said real saving, said information data storage terminal transmits a purchase request to a management device located on said communication network, and
a right acquisition unit operable to obtain the permission of real saving under the condition that there is a title saving right issued as a right to view and listen to the information data which is purchased by said user.

9. The information data storage terminal as claimed in claim 8 further provided with the functionality of leaving only license information which identifies the title saving right of said information data when deleting the information data which is really saved, and
the functionality of transmitting a delivery request providing said license information to said information data accumulation device in response to the playback operation of the information data which is deleted, and playing back the information data which is delivered in response to this request.
